(19) United States
(12) Patent Application Publication
(10) Pub. No.: US 2014/0288846 A1
(43) Pub. Date: Sep. 25, 2014

(54) SYSTEM AND METHOD TO IDENTIFY DYSREGULATED PATHWAYS AND RELATED INTERACTIONS

(71) Applicant: Case Western Reserve University, Cleveland, OH (US)

(72) Inventors: Mark R. Chance, Cleveland, OH (US); Mahmet Koyuturk, Cleveland, OH (US); Jill Barnholtz-Sloan, Cleveland, OH (US); Yu Liu, Cleveland, OH (US)

(21) Appl. No.: 14/216,147

(22) Filed: Mar. 17, 2014

Related U.S. Application Data
(60) Provisional application No. 61/794,306, filed on Mar. 15, 2013.

(51) Int. Cl. G06F 19/10

(52) U.S. Cl. CPC G06F 19/10
USPC 702/19

(57) ABSTRACT

A method can compute a cooperation profile for at least two genes according to a gene expression data set for each of a plurality of genes, the cooperation profile representing cooperation interactions dysregulated in at least one disease. A competition profile for genes according to the gene expression data set, the competition profile representing a competitive interaction between the genes. A redundancy profile can be computed for the at least two genes according to the gene expression data set for each of the genes, the redundancy profile representing a maximum expression for the genes. A dependency profile for the at least two genes can be according to the gene expression data set for each of the genes, the dependency profile representing a minimum expression for the genes. Some of the computed profiles can be analyzed to identify dysregulated interactions between gene pairs and/or dysregulated pathways.

### RELATED APPLICATION

This application claims the benefit of U.S. Provisional Application No. 61/794,306, filed Mar. 15, 2013, the subject matter of which is incorporated herein by reference in its entirety.

### TECHNICAL FIELD

This disclosure relates to a system and method to identify dysregulated pathways and related interactions.

### BACKGROUND

Genome-wide mRNA expression data can provide a rich resource for studying the molecular mechanisms of complex diseases. Through comparison of mRNA expression data between case and control samples, biomarkers and functional molecules significant for diagnosis, prognosis, and treatment have been identified for many complex diseases, including cancers. Extracting signals while rejecting noise in the data and interpreting the results to elucidate biological mechanisms relevant to disease are however, challenging. Lists of hundreds of mRNAs identified as differentially expressed are interesting but can be difficult to interpret in terms of the complex underlying biological processes. In addition, there are in many cases limited overlap between lists of individually dysregulated genes identified by different laboratories that study the same disease. To overcome these challenges, a number of methods that consider genes not as individual entities but as members of biological relevant groups have been developed. Among such methods, gene set enrichment analysis (GSEA) is very powerful and highly popular.

While being quite useful for system-level analyses, GSEA and similar methods, such as gene set analysis (GSA,) have a limitation: they focus only on the molecules (i.e., genes) that comprise a pathway and may neglect the changing interactions among genes within a pathway. Consequently, only pathways enriched in individual differentially expressed genes are detected with statistical significance. However, gene interactions and the dynamics of these interactions are also essential components of pathways and they underlie the orchestration of biological processes at many levels. Interactions are associated with several dynamic characteristics, such as their direction, strength, permanence or transience, and presence or absence. The biological influence of a pathway can be dramatically changed if the dynamics of the interactions in the pathway are altered. Indeed, several studies have demonstrated that the changes in the dynamics of interaction are associated with cancer and other diseases.

In this vein, Zhang et al. have proposed a method in which the interactions were represented by the covariances or correlations between case and control classes, and showed that this approach provides biologically meaningful results. Eddy et al. developed another method called DIfferential RAnk Conservation (DIRAC), which is based on the relative expression ranks of genes in a pathway. A limitation of this method, however, is that it assesses the change in the relationship between genes qualitatively, and misses cases in which (i) changes in expression are not large enough to change the relative order of genes or (ii) the difference between the expressions levels becomes even larger. Watkinson et al. defined the synergy among pairs of genes in terms of the mutual information between phenotype and the clustering of samples induced by the gene expression levels and extracted disease-specific interactions in cancer. Another class of algorithms for system-level analysis of differential gene expression aims to identify dysregulated subnetworks in disease. Using protein-protein interaction (PPI) networks as a template for assessing functional associations among genes, these methods identify groups of functionally related genes that exhibit collective mRNA-level differential expression with respect to disease based on: mutual information, cover-based algorithms and others. These results strongly suggest that dysregulation of interactions is as important a mechanism of disease as dysregulation of genes.

### SUMMARY

This disclosure relates to a system and method to identify dysregulated pathways and related interactions.

As one example, a method can include computing a cooperation profile for at least two genes according to a gene expression data set for each of a plurality of genes, the cooperation profile representing cooperation interactions dysregulated in at least one disease. The method can also include computing a competition profile for the at least two genes according to the gene expression data set for each of the genes, the competition profile representing a competitive interaction between the genes. The method can also include computing a redundancy profile for the at least two genes according to the gene expression data set for each of the genes, the redundancy profile representing a maximum expression for the genes. The method can also include computing a dependency profile for the at least two genes according to the gene expression data set for each of the genes, the dependency profile representing a minimum expression for the genes. The method can also include analyzing at least two of the computed profiles to identify at least one of (i) dysregulated interactions between gene pairs or (ii) dysregulated pathways.

As another example, the method can also include constructing a network of the identified dysregulated interactions based on any of the computed profiles, wherein the network comprises sets of nodes, representing gene expressions arranged by each of the identified dysregulated pathways, and edges connected between the nodes, representing the identified dysregulated interactions between gene pairs based on the analyzing. In some examples, at least one intra-pathway hub gene within at least one of the sets of nodes can be determined based on dysregulated interactions between the expression of the at least one hub gene and other genes within a respective pathway. Additionally or alternatively, the network can include a plurality of dysregulated pathways, and the method can further determine at least one cross-pathway hub interconnecting at least two of the plurality of dysregulated pathways. In some examples, an output visualization representing the network can be generated.

The method may be embodied in one or more computer readable media. In some examples one or more computers can include one or more processing units that can be programmed to execute instructions to perform such method. As an example, the method can be implemented as a service (e.g., a web service or otherwise) that is accessed via a computer network by one or more authorized users and performs the method in response to a user input.

### BRIEF DESCRIPTION OF THE DRAWINGS

FIGS. 1A-D illustrates an example of a plurality of genetic interaction profiles.

FIG. 2 illustrates an example of a network for P53 dataset using Gene Interaction Enrichment and Network Analysis (GIENA).

FIG. 3 illustrates an example of a simplified BAD pathway.

FIG. 4 illustrates an example of a network generated using the dysregulated interactions identified by GIENA on the pancreatic cancer dataset.

FIG. 5 an example of a Venn diagram of comparison of detected gene interactions.

FIG. 6 is an example of a Venn diagram of comparison of detected cooperation and redundancy interactions. Pathways detected by both profiles are similar (Table 1); the comparison of detected interactions also shows high level of similarity.

TABLE 1
Q-values for pathways detected by of GIENA and GSA for the P53 dataset

| | Cooper- | Compe- | | | |
|---|---|---|---|---|---|
| Pathway | ation | tition | Redundancy | Dependency | GSA |
| P53 | 0.005 | 0.004 | 0.007 | 0.006 | <0.001 |
| P53 hyopxia | 0.016 | 0.004 | 0.0106 | 0.006 | <0.001 |
| G1 & S | 0.035 | 0.004 | 0.037 | 0.006 | 0.005 |
| phase | | | | | |
| EPONFKB | 0.043 | 0.004 | 0.041 | 0.023 | 0.040 |
| Mitochondria | 0.043 | 0.004 | 0.041 | 0.021 | 0.032 |
| BBCELL | 0.016 | 0.004 | 0.013 | 0.024 | 0.040 |
| BAD | 0.016 | 0.004 | 0.011 | 0.021 | 0.019 |
| RAS | 0.016 | 0.047 | 0.020 | 0.006 | 0.005 |
| ASBCELL | 0.005 | 0.005 | 0.005 | 0.021 | 0.040 |
| FAS | 0.016 | 0.005 | 0.041 | 0.024 | 0.032 |
| signaling | | | | | |
| ALS | 0.043 | 0.008 | 0.041 | 0.024 | 0.032 |
| RACCYCD | 0.043 | 0.008 | 0.041 | 0.021 | 0.032 |
| Programmed | 0.016 | 0.009 | 0.009 | 0.024 | 0.040 |
| cell death | | | | | |
| FML | 0.045 | 0.05 | 0.046 | 0.026 | 0.005 |
| HSP27 | 0.016 | 0.011 | 0.016 | 0.019 | 0.007 |

q-value <0.01 is considered as significant, and highlighted in bold.

### DETAILED DESCRIPTION

### Overview

In order to further explore the dysregulation of gene interactions in disease, we have developed Gene Interaction Enrichment and Network Analysis (GIENA), which implements four mathematically simple, yet powerful interaction profile functions to model gene interactions. The hypothesis behind the analysis, suggested by the work described above, is that dysregulation of interactions, like the dysregulation of individual genes revealed by GSA, is an important set of variables to analyze to provide a comprehensive understanding of mechanisms of disease. GIENA attempts to provide a set of interaction profiles that are associated with universal biological concepts. We then use the canonical pathway information to drive a specific network analysis to indentify hub genes that may mediate communication across pathways. These profiles and their biological interpretation are as follows: (i) the sum of mRNA expression levels, which models cooperation, (ii) the difference between mRNA expression levels models competition, (iii) the maximum mRNA expression level models redundancy, and (iv) the minimum mRNA expression level models dependency between a pair of genes. This framework provides a basis for interrogating both the dynamics of multiple types of interactions and gives clues to the regulatory logic of the perturbed networks, both within pathways and across pathways, as opposed to simply identifying the dysregulated players.

We evaluated these four interaction profiles using previously published mRNA expression datasets associated with cancer. We detected multiple diseaseassociated gene interactions, which we annotated with their biological significance and compared to known literature findings to validate the results. Also, we used the approach to compare data from different experimental studies to examine the robustness of the method. Then, we constructed gene interaction networks based on these detected interactions and analyzed the results as well, in this case to better understand potential novel connections between pathways and to provide testable hypothesis for future experimental validations. Our results show that GIENA is able to reliably detect both known and novel dysregulated canonical pathways and dysregulated interaction networks related to the disease. In addition, the method gives consistent results across datasets from disparate laboratories. Overall, GIENA is systematic approach for the identification of dysregulated interactions at the pathway level and provides specific guidance for interpretation of disease-specific interactions in complex diseases.

### EXAMPLE EMBODIMENTS

Four functions, named interaction profiles, are implemented to uncover different biological mechanisms that underlie the coordinated differential expression of the genes. G={g₁, g₂, . . . , gₙ} denotes the set of genes for which mRNA expression data is available, S={s₁, s₂, . . . , sₘ} denotes the set of samples, and cⱼ denotes the phenotype of sample sⱼ. The normalized mRNA expression profile of gene gᵢ, is denoted by m-dimensional vector eᵢ such that eᵢ(j) refers to the expression of gene gᵢ in sample sⱼ (m is the number of samples).

### Cooperation (Sum of Expression)

Genes often cooperate with each other to perform various cellular functions and are organized into functional modules with densely connected genes within modules and a small number of interactions between modules. Comparing the total expression across samples of interest can reveal disruptions in cooperative function. Indeed, Chuang et al. infer the activity of a subnetwork by averaging the normalized expression values of its member genes and identify dysregulated subnetworks in terms of the mutual information between this average expression and phenotype. In our study, in order to systematically assess pairwise gene interactions, we use this concept in its simplest form: for each pair of genes, the sum of their mRNA expression levels is compared between disease and control samples to detect cooperation interactions dysregulated in diseases. Thus, we define the cooperation profile for genes gᵢ and gⱼ as

tᵢⱼ(k)=eᵢ(k) for 1≦k≦m (1)

and quantify the strength of cooperative interaction between gᵢ and gⱼ in terms of the statistical significance of the difference of tᵢ in disease and control samples.

### Competition (Difference in Expression)

If two genes are working together to balance each other's effects, assuming that their activities are correlated with mRNA expression, we can expect the difference between their mRNA expression levels to represent the regulatory balance between them. An example would include two transcription factors (TF) that act on a set of targets, but in opposite directions, i.e., one inhibits activity of the target promoter site while the other enhances activity. Consequently, changes in expression levels of these two TFs will result in maximal dysregulation of their targets when their abundance levels vary in opposite directions while their effects may be minimal when their abundance levels vary in the same direction. Motivated by these considerations, we define the competition profile of genes gᵢ and gⱼ, as

dᵢⱼ(k)=eᵢ(k)−eⱼ(K) for 1≦k≦m (2)
and quantify the strength of competitive interaction between gᵢ and gⱼ.

Such comparisons of differences in mRNA expression levels have been used in disease classification. For example, the relative expression difference of OBSCN and C9orf65 can distinguish two phenotypically similar cancers with high accuracy although the underlying biology is still unclear. This method has been applied to construct gene regulatory networks and develop prognostic test for cancer. Furthermore, Taylor et al. used difference in mRNA expression of the central hub gene in a subnetwork with its interacting partners to assess changes in the coherence of the subnetwork.

### Redundancy (Maximum Expression) and Dependency (Minimum Expression)

Besides collectively working together, genes can cooperate in other ways, one example would be the widespread genetic interactions detected in yeast (deleting either of two genes has no obvious effect, removing both will have lethal effect). For such pairs of genes, the suppression of both or over-expression of only one can be sufficient for dysfunction. To quantify its strength and detect gene interaction dysregulation in disease, we use the maximum mRNA expression for pairs of genes to define the redundancy profile of genes gi and gj as

hᵢⱼ(k)=max{eᵢ(k)−eⱼ(K)} for 1≦k≦m (3)

In cases which two genes are required for a common function, suppression of one of them or over-expression of both may lead to dysfunction. To identify such interactions, we use the minimum mRNA expression for pairs of genes to define the dependency profile of genes gᵢ and gⱼ as

lᵢⱼ(k)=min{eᵢ(k)−eⱼ(K)} for 1≦k≦m (4)

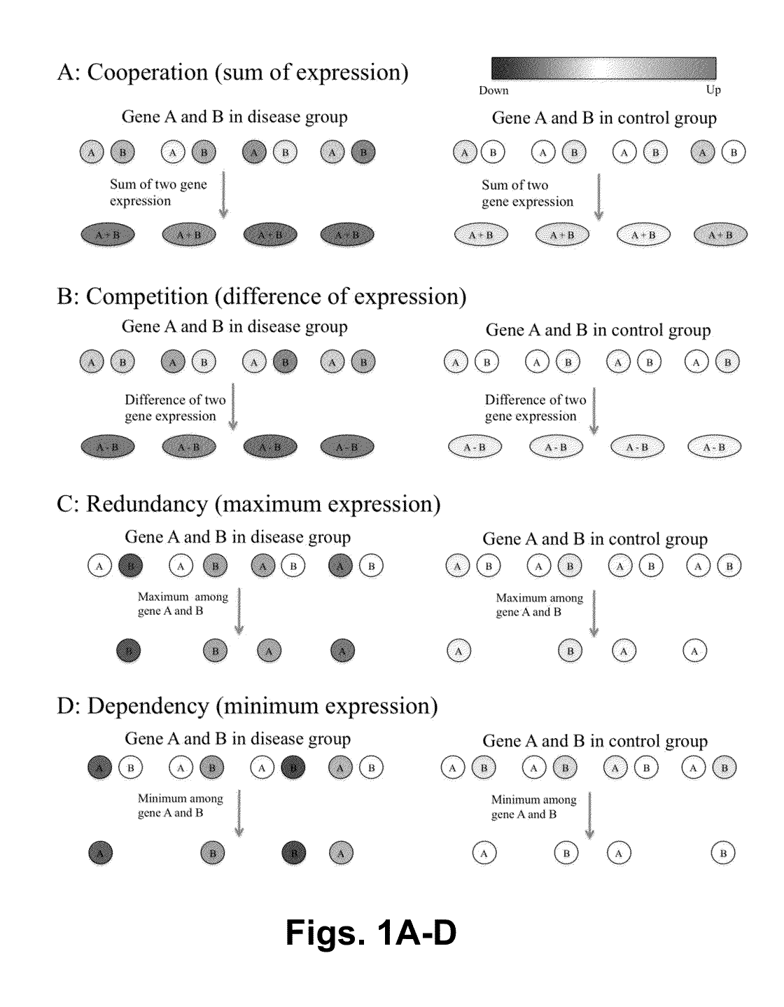

These four gene interaction profiles are conceptually illustrated in FIG. 1. Note that in each case, the change of individual gene expression might not be statistically significant, but the change of the interaction profile could become statistically significant between case and control samples. A: cooperation profile. B: competition profile. C: redundancy profile. D: dependency profile.

### Overview of GIENA

Using the four profiles described above for each pair of genes, we identify gene sets (pathways) that are enriched in dysregulated gene interactions, i.e., pathways in which these profiles are significantly altered between disease and control samples for a large number of gene pairs in the pathway. For this purpose, we use the comprehensive pathway data downloaded from the Molecular Signatures Database (MSigDB) (http://www.broadinstitute.org/gsea/msigdb). We focus on the dataset that represents canonical representations of 633 biological processes compiled by domain experts (c2.cp, version2.5). Note that the genes in a pathway in MSigDB do not necessarily interact physically with each other; thus the interactions identified here are not to be confused with physical interactions and they should be considered as higher level “relationships”.

In order to identify the dysregulated pathways, GIENA uses the framework of GSA which generalizes the original GSEA. For a pathway P with set of genes gᵢ, g₂, . . . , gₖ, the overall procedure is summarized as follows:

1) For each pair of gᵢ and gⱼ in P, the cooperation profile tᵢⱼ, competition profile dᵢⱼ, redundancy profile hᵢⱼ, and dependency profile lij are calculated for disease and control groups separately. These four profiles are used to detect dysregulated pathways independently. In the following, we use the cooperation profile t as an example to explain the procedure for detecting dysregulated pathways.

2) The classic two-sample t-statistic (4) is calculated as the standardized difference of tᵤ between disease and control groups. Repeating this procedure for each pair of genes in the pathway, a set of summary statistics Z(P)={Z₁₂ Z₁₃ . . . Z₁ₖ Z₂₃ Z₂₄ . . . Z₂ₖ . . . Z_{k-1,k}} is obtained for each pair of genes in the pathway. Note that, no hypothesis testing is done at this point; these statistics are only used to score the pathways.

3) The “maxmean” statistic S(P) for the pathway is computed to summarize Z(P). The maxmean statistic is designed to detect unusually large z-values in either or both directions. Namely, given the vector Z(P), the “maxmean” statistic is the mean of the positive or negative part of gene-pair scores in the pathway, whichever is larger in absolute value, i.e.:

S(P)=max{ΣZIJEZ+(P)zᵢⱼ/|Z+(P)|,Σzlijez−(p)Zij/|Z−(P)|} (5)

where Z⁺(P)={ZᵢⱼεZ(P): Zᵢⱼ>0} and Z⁻(P)={ZijεZ (P): Zᵢⱼ<0}. It was shown previously that this statistic is more powerful than the modified Kolmogorov-Smirnov statistic used in the original GSEA.

4) S(P) is standardized by the mean and standard deviation of tij as in GSA. An example of the theoretical underpinnings of this procedure, is disclosed in Efron B, Tibshirani R: On testing the significance of sets of genes. Annals of Applied Statistics 2007, 1:107-129.

5) The significance of S(P) is then evaluated using a permutation test. Namely, the data columns (sample labels) are permuted to generate a randomized dataset and this dataset is used to re-compute S′. Repeating this procedure for a sufficiently large number of times (B=5000 permutations are performed in our experiments), a null distribution of standardized maxmean statistics S′1, S′2, . . . , S′B, is obtained. Using this distribution, the p-value for pathway P is estimated as the number of permuted datasets that yield a larger standardized maxmean statistic than the original dataset on P, i.e., p-value (P)=|{1≦i≦B: S′i(P)≧S(P)}|/B.

6) Due to the stochastic nature of permutation test, p-values from each run will be slightly different (each single run has 5000 permutations). Thus, the permutation is repeated at least four times for each profile, and the average of the p-values is used.

7) In order to correct for multiple hypothesis testing in the procedure to detect dysregulated pathways, the q-value is calculated using the Q-value package. Pathways with q-value ≦0.01 are considered significantly dysregulated.

Similarly, the above procedure is repeated for other interaction profiles, and enriched pathways are identified for each profile separately.

### Network Construction

To construct the network enriched with dysregulated interactions, for each dyregulated pathway identified, each gene pairs are tested for dysregulation using classic t-test. To avoid the network with sparse and highly significant connections, a loose p-value threshold (0.05) without correction of multiple testing is applied.

### Gene Expression Data Sets

### P53 Mutant Data Set

The National Cancer Institute (NCI) has collected a set of human cancer cell lines (NCI-60) derived from diverse tissues, like brain, blood, breast, and colon, etc. These cell lines have been subjected to various experiments including genotyping and gene expression analysis. Consequently, a wealth of genomic and validation data is available for the well-known tumor suppressor gene p53, which regulates the expression of a large number of genes in response to various signals of cellular stress and is often mutated in human cancers. For 50 of the NCI-60 cell lines, the p53 mutational status has been tested, and 17 are identified as wild type while the rest are mutant. For these cell lines, the mRNA expression levels of 10,100 genes are also available and downloaded from http://www.broadinstitute.org/gsea/data setsj.sp. In this study, these 50 cell lines are divided into two classes based on the status of p53 (wild type vs mutant), and GIENA and GSA methods are applied to detect pathways enriched in differential interactions and genes between two classes using the mRNA expression data.

Pancreatic Cancer Data Set Pancreatic cancer is often diagnosed at advanced stages. As a consequence, very few patients survive longer than five years after diagnosis. Ishikawa et al. compared the gene expression profiles of 24 pancreatic cancer patients and 25 healthy individuals to identify novel disease pathways. We used this dataset (GSE1542) to identify the dysregulated pathways in pancreatic cancer.

### Breast Cancer Datasets

GSA and GIENA were applied on three microarray datasets from previous studies to detect pathways associated with breast cancer staging and prognosis. The datasets (GSE7390, GSE19615 and GSE26639) were divided into three groups based on the histological grading, and grades I and III were used for pathways detection. There are 30 grade 1 and 82 grade III tumors in GSE7390; 23 grade 1 and 64 grade III tumors in GSE19615 and GSE26639 contains 15 grade 1 and 121 grade III tumors. To make the latter dataset more balanced, 30 grade III tumors were randomly selected to compare with the 15 grade I tumors. GSA and GIENA were applied for each pair of grade I and III tumors respectively. The results from three datasets were compared to examine the reproducibility of the methods.

### Microarray Data Processing

Software Expander was used to process the microarray data. The robust multichip average (RMA) and quantile normalization method were applied to normalize the data, and the expressions of multiple probesets are summarized to the expression of corresponding genes using Expander, then GIENA and traditional GAS were used to detect dysregulated pathways.

### Statistical Testing of the Overlap Between Physical and Dysregulated Interactions

In order to investigate the physical bases of the dysregulated interactions identified by GIENA, we compared these interactions with PPIs downloaded from a commonly used database Human Protein Reference Database, or HPRD. For each of the datasets used (p53, breast cancer, pancreatic cancer datasets), we separately identified the pairs of genes that (i) exhibit significantly dysregulated interactions and (ii) interact in the HPRD PPI network. We assessed the statistical significance of this overlap using hypergeometric test.

To be more precise, assume that r pathways are tested for a given dataset. For 1≦i≦r, let ci denote the number of pairs of genes in pathway i such that both genes in the pair has at least one interaction in HPRD. We use the following parameters for the hypergeometric test:

└N ¼Pri

¼ 1ci: the number of gene pairs that are tested for dysregulated interaction and can potentially have a physical interaction (population size).

└n: the total number of significantly dysregulated interactions for the dataset of interest (sample size).

└m: the number of interactions in HPRD among proteins that together take part in at least one of the tested pathways, i.e., that have been tested for dysregulated interaction (total number of successes).

k: The number of gene pairs with a significantly dysregulated interactions and a physical interaction in HPRD (number of successes in the sample).
Once N, n, m, and k are obtained we compute the p-value of this observation as P∂X>¼kjN; n; mP ¼Xn i ¼ km┘i|N┐m┘n┐i|N┘n|;

i.e., the probability that there would be at least k physical interactions among significantly dysregulated gene pairs if the dysregulated interactions were chosen at random. Here, X denotes the random variable that represents the overlap between the two sets of interactions. Note that we do not correct for multiple hypotheses since only one such test is performed for each dataset.

### Gene Interaction Network Construction

Detected gene interactions are used to construct networks. These networks represent parts of the interactome which are disrupted in complex diseases. For each dysregulated pathway, interactions identified (with p-value <0.05) are collected. The network is generated and visualized using Cytoscape or other network visualization tools.

### EXAMPLE RESULTS

### GIENA Reveals Pathways and Network Dysregulated with Respect to p53 Status in NCI-60 Cell Lines

Enrichment results from GIENA and GSA for the p53 status data are shown in Table 1. GSA detects six pathways with q-values<0.01. Two of them (p53 and p53 hypoxia) are directly linked to p53. Others have obvious links to tumorigenesis, such as the RAS pathway, which is also well understood to be related to p53 expression regulation. The significant G1 & S phase pathway contains members that regulate the progression through G1-S phases of the cell cycle, such as CDK2 and CDK4. In the case of DNA damage, p53 accumulates in the cell and induces the inhibition of CDK. This pathway also includes TP53, the protein product of p53, MDM2, the master regulator of p53, and E2F, which regulates p53 indirectly.

GIENA detects over twice as many pathways at qvalues<0.01 as compared to GSA (13 pathways with q-values<0.01 vs. 6 for GSA), while missing two pathways detected by GSA, with four of the pathways, such as p53, p53 hypoxia, G1 & S phase and RAS, detected by both using the above q-value cutoff. These results suggest that mutations in p53 have profound affects at both individual gene and gene-gene interaction levels and that some of the pathways are primarily perturbed at the level of individual genes (seen by GSA alone), some are perturbed in both individual genes and in their interactions (intersecting pathways) and some are perturbed primarily at the level of interactions (seen by GIENA alone). Several pathways identified using GIENA alone are entirely confirmed by an examination of the literature. For example, the mitochondria pathway (role of mitochondria in apoptotic signaling), BAD (Regulation pathway of BAD phosphorylation), and FAS pathways are all linked to apoptosis and highly relevant to p53 functions. The BAD pathway is ranked relatively highly in the results from GSA, (eighth ranked pathway with q around 0.02), while it is assigned 5-fold more significant q-values by GIENA (0.004) based on the competition profile. BAD exhibits dysregulation at the level of both the individual gene and at the level of gene interactions and GIENA can pinpoint relevant regulatory logic of the pathway that is potentially perturbed (see below). Specifically, these observations provide a testable hypothesis that a subset of competing interactions within the BAD pathway is critical to the changes seen as a result of p53 status.

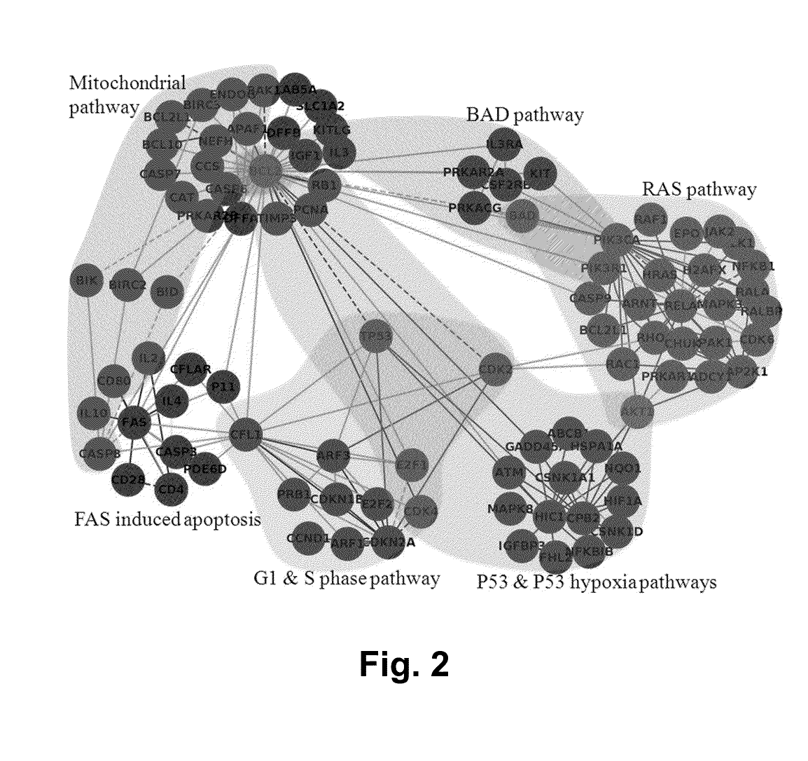

In order to leverage the pathway results to uncover potential interesting interactions across pathways, we constructed a network of dysregulated interactions in which the edges represent dysregulated interactions from any of the four profiles. To simplify the network and focus on the novel findings from GIENA, genes that are significantly differentially expressed between cases and controls at q-values<0.01, (in total three genes BAX, MDM2, and CDKN1A) are removed. Also, the 17 genes that did not have any significantly dysregulated interactions with the remaining nodes were also deleted. The sub-network after filtering is shown in FIG. 2, which has 95 nodes with 186 interactions derived from six pathways and is organized to show the underlying relevant pathways based on data from MSigDB.

The network in FIG. 2 illustrates several typical characteristics of biological networks, such as the existence of hubs. Network generated using the dysregulated interactions identified by GIENA on the P53 dataset after filtering the significantly differentially expressed genes between cases and controls, and the resulting singletons. The dashed lines indicate that physical interactions between the products of the respective genes are reported in HPRD. The green lines represent competition interactions; purple lines represent dependency interactions; orange lines represent redundancy interactions. The blue lines indicate that these interactions were detected by multiple interaction profiles. Note that there is no cooperation interaction presented in this network, because no unique pathway is detected by cooperation profile.

In FIG. 2, there are hubs clearly located within pathway gene sets (e.g., FAS in FAS induced apoptosis and BCL2 in the mitochondrial pathway) as well as hubs connecting multiple pathways. For example, TP53 (the protein product FIG. 2 of p53 gene), CFL1 (cofilin 1), and CDK2 (cyclin dependent kinase 2) exhibit significantly dysregulated interactions across at least three pathways. Although TP53 and CDK2 are not hubs within any particular pathway set, they directly link three and four dysregulated pathways, respectively. Nodes that connect more than one major regulatory module (pathway) we term “cross pathway” hubs. Interestingly some hubs exhibit only moderate differential expression between case and control (e.g., CFL1 has q-value: 0.03; FAS, 0.13; and PIK3CA, 0.14), i.e., the dysregulation of these individual genes is not captured by methods that are based on differential expression of individual genes alone. However, the interactions of these genes with other genes are disrupted in the phenotype, which is detected by GIENA. Cofilin 1 is an important regulator of the actin cytoskeleton and thus is a critical regulator of cell motility while CDK2 functions to signal the G1/S cell cycle transition. The GINEA analysis indicates that changes in the interaction of these proteins are important to the phenotypic differences relevant to p53 status. Overall, both within pathway hubs and cross pathway hubs are interesting candidates for experimental perturbation by knockdown or knockout, such experiments could define the relationship of the hub to overall phenotype and test the importance of the detected interactions. This is a stated purpose of the tool, to identify specific points of perturbation within pathways for experimental testing.

### Regulatory Logic of BAD Pathway Probed by GIENA

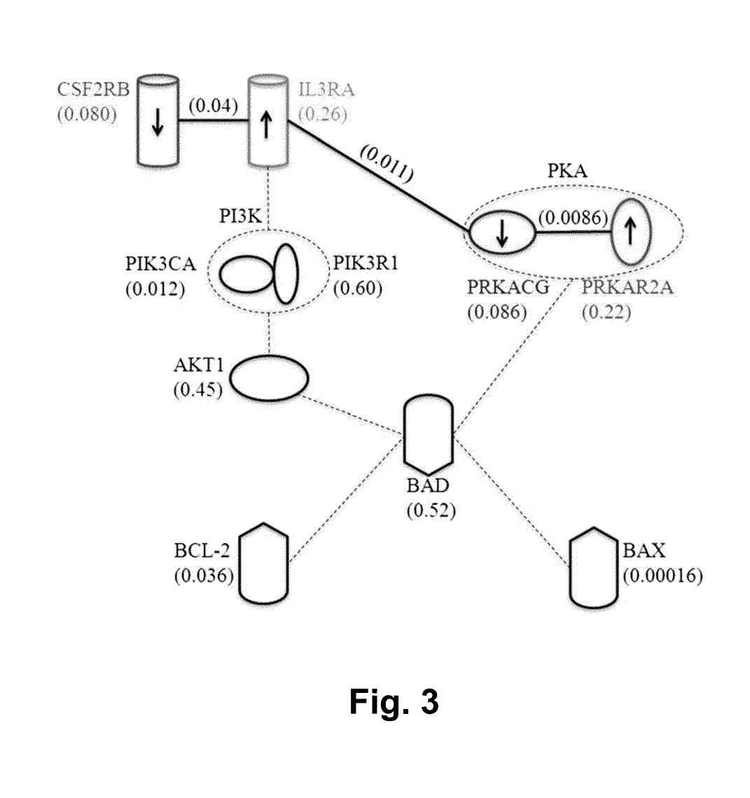

In an attempt to explore the biological significance of the network connections suggested by GIENA, we examined the details of the regulation of BAD pathway. FIG. 3 shows a simplified BAD pathway that includes: two genes that show dysregulation with respect to individual gene expression in the p53 datasets (e.g. BAX and PIK3CA), three pairs of genes that show dysregulated interactions (CSF2RB-IL3RA, IL3RA-PRKACG, and PRKACGPRKAR2A), and additional genes that connect them with BAD as the hub.

In the example of FIG. 3, solid lines represent gene interactions detected by competition profiles using mRNA expression. Dashed lines indicate the physical interactions. The numbers beneath the gene names are p-values corresponding to the expression change between mutant p53 and wild type p53 samples. The numbers above lines are p-values for the change in the competition profile for two genes connected between mutant p53 and wild type p53 samples. The arrows inside the gene symbols indicate the trends of the mRNA expression of mutant p53 samples in respect to p53 wild type samples, though the change is not statistically significant.

The dysregulation of the genes BAX and PIK3CA provided a q-value of 0.02 in the GSA based analysis of this pathway while the competition profile from GIENA generated greater significance with a q-value of 0.004 (Table 1). Thus, an examination of interactions provides greater confidence in establishing dysregulation of this pathway than examining dysregulated genes alone. In examining the individual gene p-values, we can see that neither CSF2RB, IL3RA, PRKACG, nor PRKAR2A are dysregulated at the individual gene level, their interactions that show significant changes between phenotype and control (FIG. 3). Detailed inspection of the expression patterns of these genes shows that CSF2RB is slightly (but not significantly, p-value 0.08) down regulated in case vs. control while IL3RA is slightly up-regulated (but not significantly, p-value 0.26). IL3RA gene encodes the interleukin 3 specific ligand binding subunit of a receptor heterodimer complex where the signaling domain is shared among and responds to multiple ligands, including colony stimulating factor 2. Thus, we suggest that the reciprocal expression changes in the CSF2RB-IL3RA pair provide a finely tuned system for maintaining molecular balance in downstream signaling to PI3K, and subsequently to AKT1 and BAD, which can provide tight control for apoptosis signaling overall. This concept of molecular balance has been previously elaborated for PI3K signaling. Note that the competition profile also reveals potential regulation by molecular balance in the PRKACG-PRKAR2A (cyclic AMP dependent protein kinase gamma catalytic subunit and type-II alpha regulatory subunit) ligand receptor interactions as well. Thus, the use of the competition profile revealed sub-components of the BAD pathway that are involved in maintaining tight molecular balance of signaling, changes that could not be detected by individual gene expression alone.

### GIENA Discovers Dysregulated Pathways and Networks in Pancreatic Cancer

Enrichment results from GSA and GIENA for the pancreatic cancer data are shown on Table 2. GSA does not detect GIENA detects nine pathways, including glycosphingolipid biosynthesis, ACE2 (angiotensin-converting enzyme 2), and several complement pathways. Some of these pathways were previously shown to be related to cancer but not much is known about them in pancreatic cancer. Complement pathways are related to cell killing, recent studies have shown that an activated complement pathway can kill tumor cells, thus, its association with pancreatic cancer is logical. The angiotensin converting enzyme precursor 2 (ACE2) pathway is top ranked with a q-value 0.004;ACE2 protein is a component of the renin-angiotensinaldosterone system (RAAS), which regulates blood pressure and water (fluid) balance. Recent studies show that ACE2 is down-regulated in some cancers. In terms of other significant pathways accumulation of glycosphingolipid has been observed in cancer cells and it has been shown that activated complement pathways can kill tumor cells. These results suggest that the alterations in the expression of single genes are often subtle in pancreatic cancer and these pathway alterations can be captured only when interactions are considered.

TABLE 2
Q-values of pathways detected by GIENA for the pancreatic cancer dataset

| | Co- | Com- | Redun- | | |
|---|---|---|---|---|---|
| Pathway | operation | petition | dancy | Dependency | GSA |
| Glycosphingolipid | 0.018 | 0.002 | 0.004 | 0.027 | |
| biosynthesis | | | | | |
| Classic | 0.047 | 0.003 | 0.040 | 0.027 | |
| complement | | | | | |
| activation | | | | | |
| Classic | 0.047 | 0.003 | 0.034 | 0.027 | |
| Classic & | 0.047 | 0.004 | 0.039 | 0.026 | |
| alternative | | | | | |
| complement | | | | | |
| ACE2 | 0.047 | 0.004 | 0.027 | 0.026 | |
| Bisphenol A | 0.049 | 0.009 | 0.048 | 0.027 | |
| degradation | | | | | |
| Lysine | 0.037 | 0.009 | 0.040 | 0.028 | |
| degradation | | | | | |
| Renin-angiotensin | 0.047 | 0.009 | 0.035 | 0.027 | |
| system | | | | | |
| Glycosphingolipid | 0.018 | 0.026 | 0.004 | 0.027 | |
| biosynthesis (neo- | | | | | |
| lactoseries) | | | | | |

q-value <0.01 is considered as significant, and highlighted in bold. Note none of pathways has significant q-value using GSA.

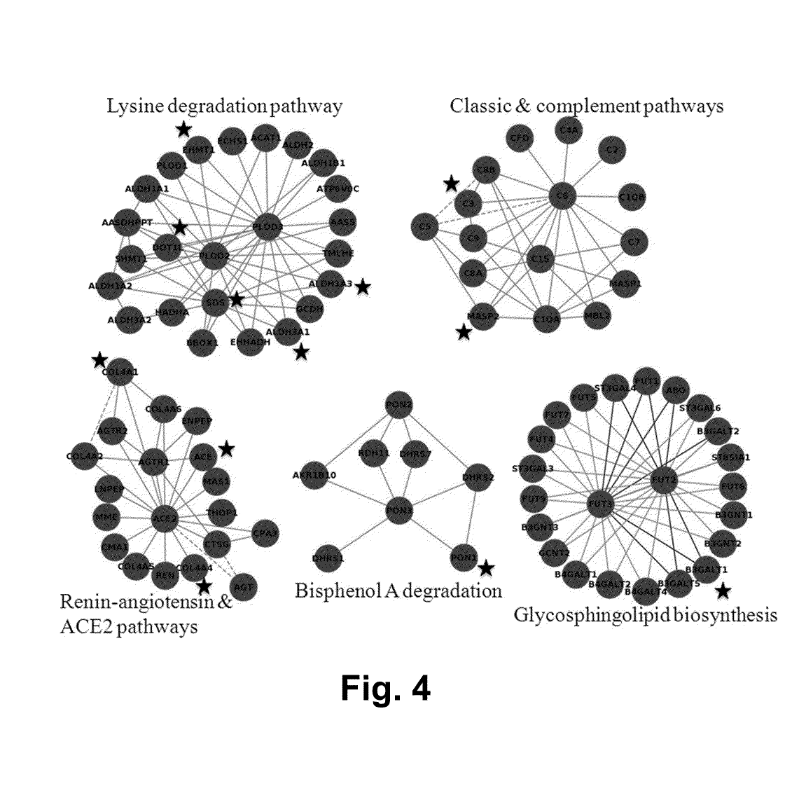

The network generated using the dysregulated interactions detected by GIENA on the pancreatic cancer dataset is shown in FIG. 4. Note that there is no significantly any pathway with a significant q-value. In comparison, differentially expressed gene (0.01 q-value level). The network has five separate pathways without identification of cross pathway hubs involved across the disparate pathways. It may be that multiple unlinked pathways are dysregulated in pancreatic cancer or that important cross pathways hubs proteins are as yet unidentified due to limited coverage in interaction databases. However, within the five pathways several hub genes are identified, such as, fucosyl transferase 3 (FUT3), Procollagen-lysine 2-oxoglutarate 5-dioxygenase 3 (PLOD3), paraoxanase 3 (PON3) and ACE2 and these are interesting targets for further experimental investigation in the disease.

To confirm the GIENA findings, the results are compared with that of Jones, et al., which identified genes mutated in pancreatic cancer by genome-wide proteincoding-gene sequencing of 24 patients. Comparison of this data to our pancreatic cancer networks shows that the dysregulated networks identified by GIENA contain 12 mutated genes, and each network has at least one mutated gene (FIG. 4, mutated genes are marked with a star). In particular, five mutated genes are present in the lysine degradation network including: two aldehyde dehydrogenases (ALDH1A3 and ALDH3A1), DOT1-like histone H3 methyltransferase (DOT1L), euchromatic histonelysine N-methyltransferase 1 (EHMT1), and serine dehydratase (SDS). More interestingly, although there is no evidence of physical interaction between them in HPRD (Human Protein Reference Database), GIENA suggests that SDS interacts with ALDH1A3, ALDH3A1 and DOT1L (FIG. 4). Thus, the pathways detected by GIENA are supported by recent mutation data. In addition, the epistatic effects of the mutations are predicted by the GINEA framework.

Pathways Associated with Breast Cancer Prognosis are Consistent Across Datasets

Breast cancer prognosis is largely driven by the assessment of key clinical characteristics, such as tubule formation, mitotic rate, and nuclear pleomorphism; these are generally combined in a clinical grade. This approach has become a widely used strategy in the assessing risk of disease relapse and estimating the benefit of a treatment strategy. More recently, genomic profiling combined with clinical information was used to refine prognosis and improve therapeutic strategies for breast cancer. As outlined in the methods section, we have identified gene expression data sets nominally associated with stages I and III. To identify pathways that vary between the relevant stages, GSA and GIENA were applied to three previously published datasets]. GIENA detected 11 pathways with significant q-values in at least two datasets (Table 3). Most are clearly associated with tumorigenesis and development including changes in interactions of SRC (oncogene) and RB (suppressor) pathways. Overall, more than half of the detected pathways are related to cell cycle (such as cell cycle, P27, Cyclin, CDC25, G2 and M phase transition, and G2 pathways) and are significantly dysregulated for grades I vs. III. Of these 11 pathways all but two were detected by GSA (Table 4). The two pathways missed by GSA are FBW7 and P27 pathways, FBW7 is a well-known tumor suppressor and P27 is associated with breast tumor prognosis. Moreover, both pathways are ranked in top 25 pathways of GSA results for all three datasets, but with q-values below the threshold, and all pathways detected by GSA are also detected by GIENA. These results suggest that in breast cancer most pathways are dysregulated at both the individual gene and at the level of interaction.

TABLE 3
Q-values of pathways detected by GIENA for three breast cancer datasets

| | Cooperation | | | Competition | | | Redundancy | | | Dependency | | |
|---|---|---|---|---|---|---|---|---|---|---|---|---|
| | Dataset | Dataset | Dataset | Dataset | Dataset | Dataset | Dataset | Dataset | Dataset | Dataset | Dataset | Dataset |
| Pathways | 1 | 2 | 3 | 1 | 2 | 3 | 1 | 2 | 3 | 1 | 2 | 3 |
| P27 | 0.027 | 0.021 | 0.0073 | 0.0073 | 0.019 | 0.016 | 0.023 | 0.038 | 0.19 | 0.014 | 0.010 | 0.0062 |
| FBW7 | 0.018 | 0.021 | 0.0071 | 0.0071 | 0.019 | 0.016 | 0.021 | 0.030 | 0.019 | 0.0062 | 0.200 | 0.010 |
| PTC1 | 0.018 | 0.0073 | 0.010 | 0.010 | <0.0001 | 0.0014 | 0.012 | 0.013 | 0.019 | 0.0097 | 0.015 | 0.025 |
| Cell Cycle | 0.018 | 0.18 | 0.010 | 0.010 | 0.0082 | 0.014 | 0.21 | 0.032 | 0.019 | 0.0043 | 0.0020 | 0.017 |
| SRCRPTP | 0.0021 | <0.001 | 0.0063 | 0.0063 | 0.0022 | 0.0016 | 0.0018 | 0.002 | 0.0036 | <0.0001 | 0.0010 | 0.012 |
| G2 &M phase | 0.0095 | 0.0056 | 0.010 | 0.010 | 0.0015 | 0.0014 | 0.014 | 0.020 | 0.019 | 0.0017 | 0.0010 | 0.017 |
| Cyclin | 0.018 | 0.015 | 0.010 | 0.010 | 0.0017 | 0.016 | 0.021 | 0.029 | 0.018 | 0.0021 | 0.0010 | 0.010 |
| RB | 0.0095 | 0.0078 | 0.0071 | 0.0071 | 0.0081 | 0.0016 | 0.014 | 0.020 | 0.018 | 0.0017 | 0.0023 | 0.017 |
| G2 | 0.0021 | 0.0056 | 0.010 | 0.010 | 0.0082 | 0.016 | 0.0018 | 0.013 | 0.019 | 0.0014 | 0.0023 | 0.020 |
| SKP2E2F | 0.0015 | 0.018 | 0.0071 | 0.0071 | 0.019 | 0.016 | 0.019 | 0.025 | 0.018 | 0.0043 | 0.015 | 0.0086 |
| CDC25 | 0.0035 | 0.0033 | 0.0073 | 0.0073 | 0.0082 | 0.016 | 0.0093 | 0.013 | 0.018 | <0.0001 | 0.0010 | 0.017 |

q-value < 0.01 is considered as significant, and q-values for pathways with significant q-values for at least two datasets are highlighted in bold.
Two pathways detected by GIENA only are in italics.
Dataset 1: GSE7390; Dataset 2: GSE19615; Dataset 3: GSE26639.
Only pathways detected by at least two datasets listed.
Both P27 and FBW7 pathways are in top 25 pathways in normal GSA results in all three datasets.

TABLE 4
Q-values of pathways detected by GSA for the three breast cancer datasets

| | Dataset 1 | Dataset 2 | Dataset 3 |
|---|---|---|---|
| PTC1 | 0.0077 | 0.072 | 0.013 |
| Cell Cycle | <0.0001 | 0.00027 | 0.0072 |
| SRCRPTP | 0.0020 | 0.0027 | 0.0043 |
| G2 &M Phase | 0.0048 | 0.0025 | 0.0075 |
| Cyclin | 0.019 | 0.0072 | 0.0050 |
| RB | 0.0048 | 0.0030 | 0.0072 |
| G2 | 0.0020 | 0.00027 | 0.011 |
| SKP2E2F | 0.0069 | 0.012 | 0.0070 |
| CDC25 | 0.0022 | 0.00027 | 0.0075 |

q-value <0.01 is considered as significant.
Only pathways detected by at least two datasets are listed.
Dataset 1: GSE7390;
Dataset 2: GSE19615;
Dataset 3: GSE26639.

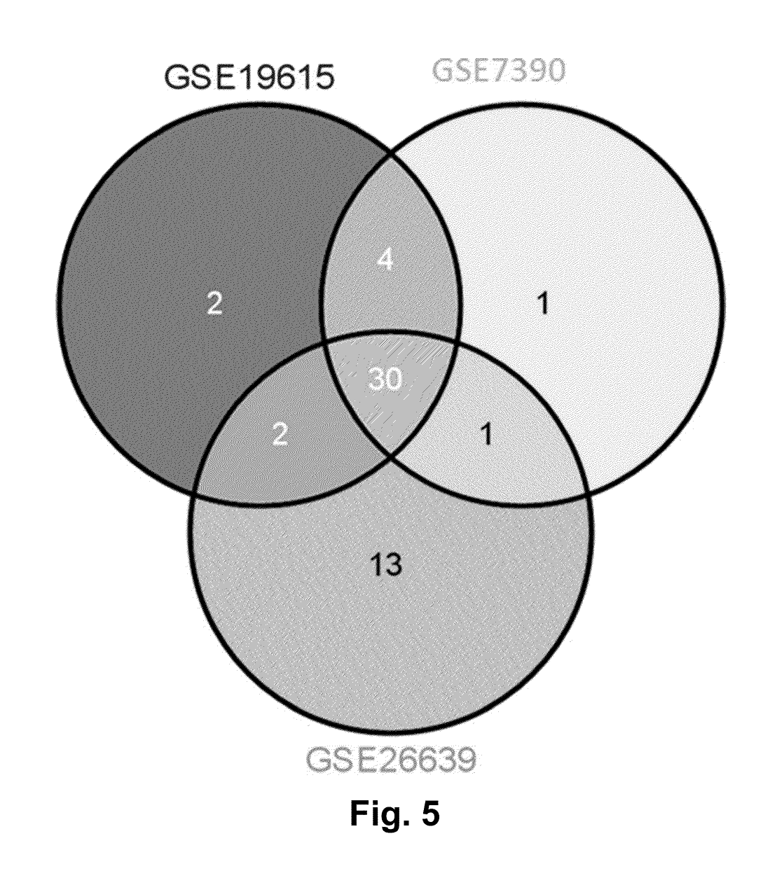

Microarray data are often noisy, and consequently, the reproducibility often is low across datasets from different laboratories for the same disease. We further examined the consistency of the pathways detected by GIENA across three datasets. In total, 22 pathways are assigned significant q-values for at least one dataset (data not shown) and 11 of 22 are significant for at least two datasets (Table 3), while the others are often ranked in the top 50 pathways. We also examined the consistency of gene interactions detected by GIENA. For P27 pathway identified by GIENA only, we investigated the overlap of gene interactions among three datasets. Results show that 65-83% interactions are shared among all three datasets (FIG. 5), and a pairwise comparison between GSE7396 and GSE19615 shows even higher overlap; more than 92% of interactions are shared. Similar overlap is observed for FBW7 pathway, which is also detected by GIENA, but not GSA. It should be noted that results from dataset GSE26639 is most dissimilar from the other two, possibly due to its small sample size (it has the smallest number of grade I patients). In summary, GIENA results are robust and consistent across different datasets in identification of both gene interactions and pathways and provide results consistent with the literature.

### Comparison of Interaction Profiles Detected in Different Pathways

With reference to FIG. 5, to test the reproducibility of GIENA, the detected interactions for P27 pathway are pair-wisely compared for three breast cancer datasets. Majority of the interactions are detected in all three datasets. For instance, more than 90% of interactions are shared between GSE19615 and GSE7390.

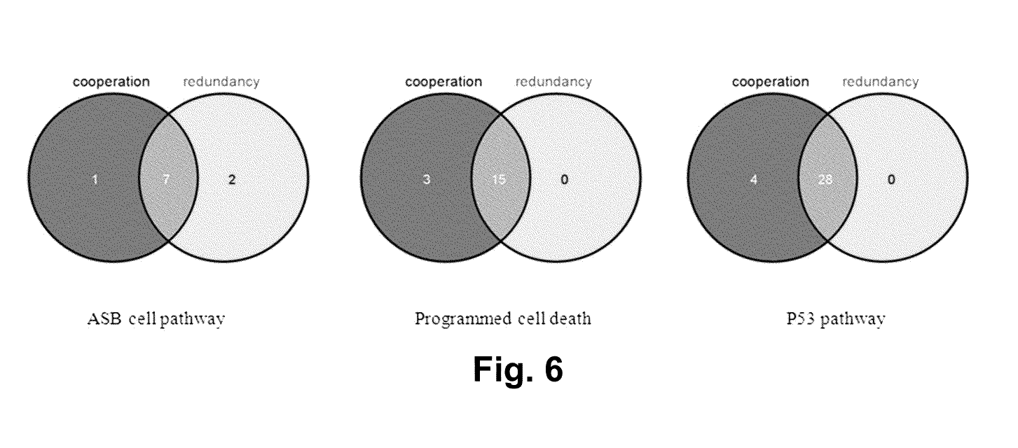

In order to investigate the biological relevance of the four proposed interaction profiles (cooperation, competition, redundancy and dependency), we compared enrichment results for the four profiles. The comparison shows that the detected pathways are different among most of the four profiles in many cases (the exception is cooperation and redundancy, see below), which might reflect the various underlying biological processes of complex diseases, e.g., in some conditions the genes compete to influence phenotype; in others, cooperation might drive dysregulation. Pathways detected by cooperation (sum) and redundancy (higher) profiles are similar in the results from the p53 dataset, e.g. the p53, ABSCELL, and programmed cell death pathways are identified by both approaches. In fact many gene interactions from these two profiles are significant for these pathways (FIG. 6). This is not surprising, since if the expression of one of the genes involved in the interaction changes dramatically, and the expression of this gene is much higher than the other gene, then the sum and higher expression of the two genes will converge to each other. The competition profile has a strong influence on the identified pathways, as seen in FIGS. 2 and 4 (green line represents interactions detected by competition profile). The reason is not obvious, and further investigation is needed to reveal it. It should be noted that the four profiles are related, for example, the absolute difference equal to the difference of maximum and minimum profiles. However, the information on the directionality would be missed if difference were replaced by absolute difference. To further investigate the performance of four profiles, we investigated the number of overlapping pathways detected by two profiles in three breast cancer datasets. The results from three datasets are highly similar; table 5 lists the results from dataset 1 (GSE7390). Overall, three profiles (cooperation, competition, and dependency) contribute to the identification of dysregulated pathways in breast cancer datasets. Although all pathways detected by redundancy profile are identified by other profiles in breast cancer cases, it did identify one unique pathway in pancreatic cancer dataset (Glycosphingolipid biosynthesis, table 2). Therefore it is useful to consider all four profiles to comprehensively identify significantly dysregulated pathways due to the high heterogeneity of cancer datasets.

In the example of FIG. 4, no genes were identified as differentially expressed between pancreatic cancer and normal cells. The dashed lines indicate that physical interactions between the products of the respective genes are reported in HPRD. See FIG. 2 legend for color coding of interactions for use in the example of FIG. 4. The mutated genes detected by Jones et al. are marked by a star.

### Nature of Detected Interactions

It has been repeatedly shown that human diseases are associated with perturbations of physical PPIs. In order to investigate the nature of the dysregulated interactions identified by GIENA, we compare these interactions with physical PPIs downloaded from HPRD. The results show that the overlap between PPI and detected gene interactions are significant in the p53 dataset: among 215 detected gene interactions in p53 dataset, 23 pairs also physically interact with each other in a network of PPIs (p-value<1.2×10-4). In the case of the pancreatic cancer dataset, 5 out of 173 gene pairs have physical interaction in HPRD (p-value<0.13). This observation suggests that, while a significant number of dysregulated interactions stem from physical interactions, the nature of many gene interactions may be indirect and mediated by other genes, or their interactions are not discovered by current experiments due to the overall low coverage of the interactome in HPRD.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In view of the foregoing, GIENA generalizes the gene-based enrichment method to detect pathways that are dysregulated in diseases based on changes in multiple types of interactions. Three datasets are used to demonstrate its potential; the results reveal several well-known and biologically meaningful pathways associated with cancer; and the results are highly reproducible. Comparison with GSA indicates that the system and method disclosed herein are comprehensive and efficient in terms of extracting weak signals and identifying pathways that are statistically significant but that a combination of GIENA with one or more other approaches can provide a more comprehensive survey of pathway level dysregulation.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A method comprising:
computing a cooperation profile for at least two genes according to a gene expression data set for each of a plurality of genes, the cooperation profile representing cooperation interactions dysregulated in at least one disease;
computing a competition profile for the at least two genes according to the gene expression data set for each of the genes, the competition profile representing a competitive interaction between the genes;
computing a redundancy profile for the at least two genes according to the gene expression data set for each of the genes, the redundancy profile representing a maximum expression for the genes;
computing a dependency profile for the at least two genes according to the gene expression data set for each of the genes, the dependency profile representing a minimum expression for the genes;
analyzing at least two of the computed profiles to identify at least one of (i) dysregulated interactions between gene pairs or (ii) dysregulated pathways.

2. The method of claim 1, further comprising constructing a network of the identified dysregulated interactions based on any of the computed profiles, wherein the network comprises sets of nodes, representing gene expressions arranged by each of the identified dysregulated pathways, and edges connected between the nodes, representing the identified dysregulated interactions between gene pairs based on the analyzing.

3. The method of claim 2, further comprising determining at least one intra-pathway hub gene within at least one of the sets of nodes based on dysregulated interactions between the expression of the at least one hub gene and other genes within a respective pathway.

4. The method of claim 2, wherein the network includes a plurality of dysregulated pathways, the method further comprising determining at least one cross-pathway hub interconnecting at least two of the plurality of dysregulated pathways.

5. The method of claim 2, wherein the network includes a plurality of dysregulated pathways, the method further comprising:
determining at least one intra-pathway hub gene within at least one of the sets of nodes based on dysregulated interactions between the expression of each intra-pathway hub gene and other genes within a respective pathway; and
determining at least one cross-pathway hub gene interconnecting at least two of the plurality of dysregulated pathways.

6. The method of claim 5, further comprising generating an output visualization representing the network.

7. The method of claim 2, further comprising generating an output visualization representing the network.

8. The method of claim 1, wherein computing the cooperation profile further comprises:
computing a sum of mRNA expression levels for each pair of genes for a disease sample;
computing a sum of mRNA expression levels for each pair of genes for a control sample; and
determining the cooperation interactions dysregulated in the at least one disease based on evaluating the computed sum for the disease sample with the computed sum for the control sample.

9. The method of claim 1, wherein computing the competition profile further comprises:
computing a difference between mRNA expression levels for each pair of genes for a disease sample;
computing a difference between mRNA expression levels for each pair of genes for a control sample; and
determining the competitive interaction between the genes in the at least one disease based on evaluating the computed difference for the disease sample with the computed difference for the control sample.

10. The method of claim 1, wherein computing the redundancy profile further comprises computing a maximum of mRNA expression for each pair of genes.

11. The method of claim 1, wherein computing the dependency profile further comprises computing a minimum of mRNA expression for each pair of genes.

12. One or more non-transitory computer-readable media comprising the method of claim 1.

13. A computer, comprising:
a processor; and
memory to store instructions executable by the processor to perform the method of claim 1.

14. A method comprising:
computing a cooperation profile for at least two genes according to a gene expression data set for each of a plurality of genes, the cooperation profile representing cooperation interactions dysregulated in at least one disease, wherein computing the cooperation profile further comprises:
the computing a sum of mRNA expression levels for each pair of genes for a disease sample;
computing a sum of mRNA expression levels for each pair of genes for a control sample; and
determining the cooperation interactions dysregulated in the at least one disease based on evaluating the computed sum for the disease sample with the computed sum for the control sample;
computing a competition profile for the at least two genes according to the gene expression data set for each of the genes, the competition profile representing a competitive interaction between the genes, wherein computing the competition profile further comprises:
computing a difference between mRNA expression levels for each pair of genes for the disease sample;
computing a difference between mRNA expression levels for each pair of genes for the control sample; and
determining the competitive interaction between the genes in the at least one disease based on evaluating the computed difference for the disease sample with the computed difference for the control sample
computing a redundancy profile for the at least two genes according to the gene expression data set for each of the genes, the redundancy profile representing a maximum expression for each pair of the genes;
computing a dependency profile for the at least two genes according to the gene expression data set for each of the genes, the dependency profile representing a minimum expression for each pair of the genes;
analyzing at least two of the computed profiles to identify (i) dysregulated interactions between gene pairs and (ii) a plurality of dysregulated pathways;
constructing a network of the identified dysregulated interactions based on any of the computed profiles, wherein the network comprises sets of nodes, representing gene expressions arranged by each of the identified dysregulated pathways, and edges connected between the nodes, representing the identified dysregulated interactions between gene pairs based on the analyzing;
determining at least one intra-pathway hub within at least one of the sets of nodes in the network based on dysregulated interactions between the expression of the hub gene and other genes within a respective pathway;
determining at least one cross-pathway hub interconnecting at least two of the plurality of dysregulated pathways in the network; and
generating an output representing the network.

15. One or more non-transitory computer-readable medium comprising the method of claim 14.
